(19) United States
(12) Patent Application Publication
(10) Pub. No.: US 2004/0128518 A1
(43) Pub. Date: Jul. 1, 2004

(54) Information access system, device and method

(76) Inventors: F. Mervyn Cavers, Winnipeg (CA); Stephen E. Dearth, Winnipeg (CA)

Correspondence Address: STEPHEN E. DEARTH, 72 RED WILLOW CRESCENT, WINNIPEG, MB, R2J 4G4, CA

(21) Appl. No.: 10/445,873

(22) Filed: May 28, 2003

Related U.S. Application Data
(60) Provisional application No. 60/383,598, filed on May 29, 2002.

(51) Int. Cl. H04L 9/00

(52) U.S. Cl. 713/185

(57) ABSTRACT

According to one aspect of the invention there is provided an information access system comprising: a database; at least one data record in the database; a password access control for the database providing access to a record in the database only in response to presentation of a password unique to that record; password record media recording respective ones of the passwords; and, a medium carrier containing each password record medium and securing the password record medium against access, the password record medium being releasable from the carrier only upon destruction of the integrity of the carrier. This system provides a “one-time” access to a record. Once a record has been accessed, a new password, a new record medium and a new medium carrier are produced for the authorized user.

### FIELD OF THE INVENTION

The present invention relates to an information access system, and more particularly to a system for controlling access to confidential information.

### BACKGROUND

Certain types of information are considered to be confidential, to be released only to persons with a need to have the information. One example is personal medical records, which were the initial interest in developing this invention. The invention is, however, applicable to other types of information, for example financial information, criminal records, wills and testaments. While the information is to be maintained in confidence, there are occasions when it should be readily available to certain individuals, for example medical personnel.

### THE NEED FOR ACCESS

Concerns over health records accessibility involve the basic questions of where the records should be kept and, if it is possible to, access them whenever and wherever they were needed. Current medical alert bracelets do not carry enough information for every need. Medical chips cannot easily be kept up to date. With the widespread reach of the Internet it is now possible to access information world wide. Perhaps an individual on vacation needs medical attention. Some individuals have special medical needs or special medical conditions that require repeated or ongoing access to their medical records. Persons may be seeing one or more specialists who require an in-depth knowledge of the patient's medical history. For these and many other reasons, medical records need to be stored in an accessible format, available to those who require it—yet they should also be safe and inaccessible to all others.

### SUMMARY

According to one aspect of the invention there is provided an information access system comprising:

a database;

at least one data record in the database;

a password access control for the database providing access to a record in the database only in response to presentation of a password unique to that record;

password record media recording respective ones of the passwords; and

a medium carrier containing each password record medium and securing the password record medium against access, the password record medium being releasable from the carrier only upon destruction of the integrity of the carrier.

This system provides a “one-time” access to a record. Once a record has been accessed, a new password, a new record medium and a new medium carrier are produced for the authorized user.

The use of this system and certain alternative embodiments of the system and apparatus, and the method of the record keeping are described more fully in the following in connection with medical records, through the use of the invention as a world-wide health information access system. A small device serving as the record medium, placed in a credit card, watch or bracelet as the medium carrier, may contain a person's health information ID and a health information password. The ID is a medical record account identifier that uniquely identifies individual's records, much like a credit card number or bank account number. The password is a secret sequence of letters, numbers or other symbols that will allow someone to access and decode the medical records. The ID and password are stored inside the device, in a tamper-proof enclosure. When the device is issued, the ID and password are not visible. They are only accessible if the integrity of the device is destroyed, for example by breaking it in half, in a non-repairable way. In an emergency or other legitimate access situation the device is meant to be broken in half; allowing the owner, a health care provider or emergency medical personnel to use the device to access the owner's medical records. After legitimate use, the owner may have a new device issued, and his records re-encrypted with a new password. However, if the device has been breached without authorization, the owner will be able to tell that the device was tampered with and if his records were viewed.

### BRIEF DESCRIPTION OF THE DRAWINGS

In the accompanying drawings, which illustrate an exemplary embodiment of the present invention:

FIG. 1 is a schematic representation of a system according to the present invention; and

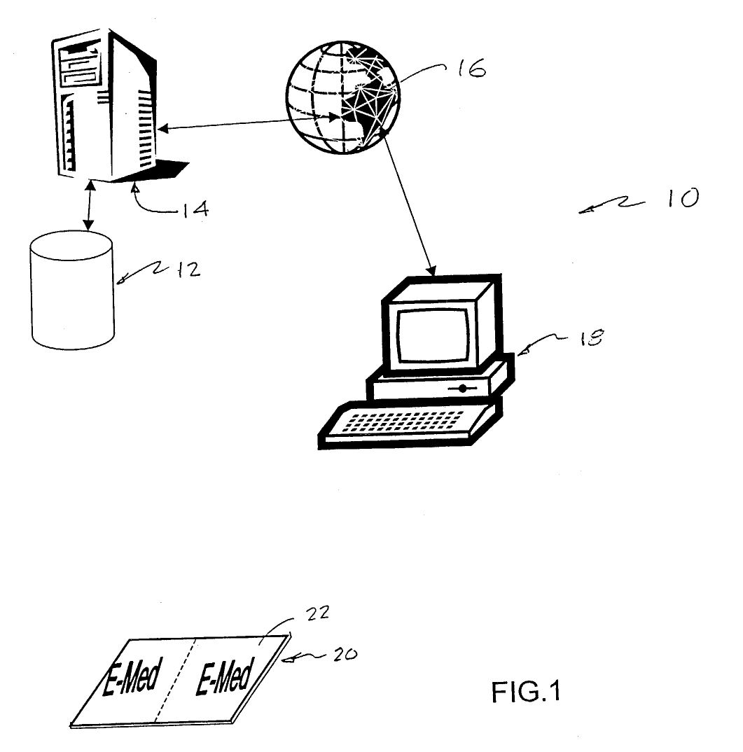

FIG. 2 is an isometric view of a card-type media carrier, shown broken open for access to the record medium.

### DETAILED DESCRIPTION

Referring to the accompanying drawings, there is illustrated a system 10 according to the invention. The system includes a storage mechanism 12 coupled to a server 14. The server is connected to the Internet 16. The server may be accessed over the Internet by a terminal 18.

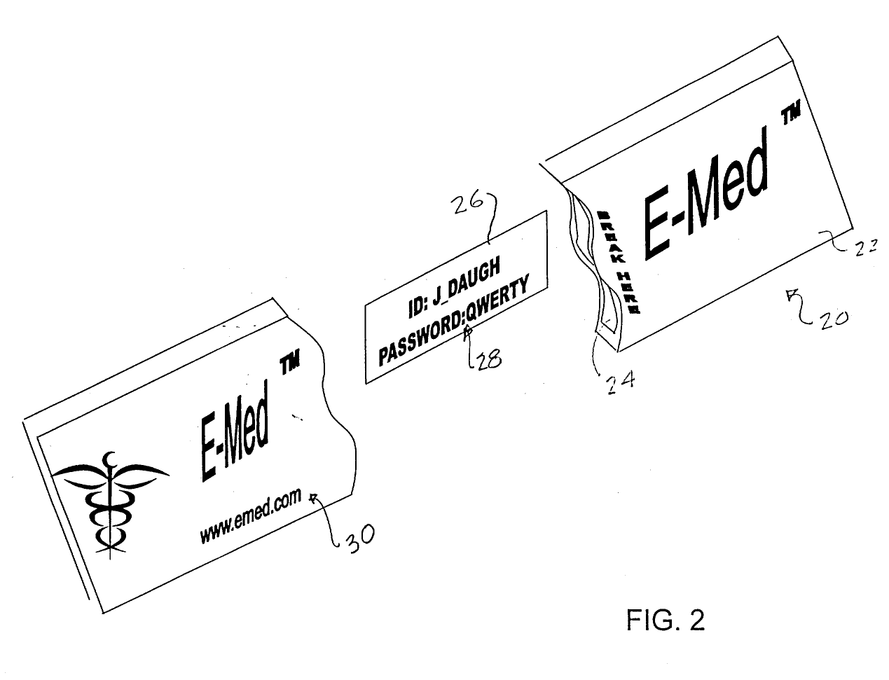

The remaining component of the system is an access information device 20. This is a card 22 of frangible plastic. The card is an information record medium carrier. It has an internal compartment 24 that is inaccessible from the exterior of the card unless the card is broken as illustrated FIG. 2. The compartment houses a record medium 26. In this case, the record medium is a sheet with access data 28 recorded on it. The carrier is also a carrier for printed information 30. To access the records in the data storage 12, server 14 is accessed through the Internet using the terminal 18. The ID information identifying the record to be accessed is entered at the terminal 18 and passed to the server 14, which demands the entry of a secure password to provide access to the record. The secure password is given on the record medium 26 and can only be determined by destroying the integrity of the data access information device 20.

The use of the invention will be further described in the following by way of example.

### EXAMPLE 1

A subscriber to the system is on vacation and falls ill. Upon visiting a local doctor, the subscriber's medical records are required. The media carrier card 22 is cracked open, and the access information record medium is given to the doctor. The doctor uses the ID and password on the record medium to access the subscriber's records online, notes which medications are being taken, past medical conditions, examines the subscriber and then prescribes a treatment that is appropriate for the illness. The doctor also records this information online for review by the subscriber's regular doctor. Upon the subscriber returning home, his or her doctor views the records submitted by the attending physician and adds an appropriate entry to the online medical records. A new password and, where desired, a new ID are created and a new access device is prepared and given to the subscriber.

### EXAMPLE 2

A subscriber is involved in a car accident. The subscriber is unconscious, and unable to notify emergency medical personnel that the subscriber is currently taking prescription drugs and has a pre-existing heart condition. However, the subscriber has taken the precaution of wearing a bracelet record medium carrier, and those treating the subscriber locate it and read it. They recognize the device, the web site address and instructions given on it, so it is broken open, allowing them to access the subscriber's records, noting medical condition and medication. The subscriber's life is saved due to the availability of medical history and information.

Privacy and Security

The patient's records are stored electronically in a database managed by the patient's doctor and housed by a private company with whom the owner has signed an agreement. The contents of this electronic record are reviewed and approved by the patient in consultation with her/his personal physician. The agreement guarantees privacy to the owner and denies access to anyone who does not have access to the device and code inside. Government, insurance companies, and anyone else, to whom the owner has not given express permission, by providing the device and code, cannot obtain access to the records in any other way. The medical information stored online is not the only patient record, as the owner's doctor and other health care institutions may also have patient records. However the copy stored in the database is the only copy that is accessible worldwide.

Process and Updates

For ongoing protection, medical records must be kept up to date. A doctor will manage this process. The process of capturing, validating and storing the records for a given individual will be invoked from time to time as the medical records are in need of updating. These updates can be submitted to a subscriber's doctor by any qualified or authorized doctor, medical professional or medical institution. However the subscriber's doctor will review these submissions and add them to the records. The subscriber's primary care physicians are responsible for review, maintenance and accuracy of the, records, just as they are today in our current health care system.

The Device

Embodiments of the media carrier are intended to have properties that allow them to perform the functions described above. The preferred characteristics of the carrier with record medium include the following:

1) It is tamperproof. Once it has been assembled, it cannot be opened without breaking the device completely, thereby revealing the hidden information and marking the device as having been opened.

2) It is resistant to x-rays or other attempt to view the contents without opening the device.

3) It may be small enough to be stored in a wallet, carried in a purse, worn on a necklace, ring or other jewellery.

4) It may use encryption coding for the transmission of the data, similar to that used by banks for Internet banking, but may be more secure, utilizing more digits for key and access code.

5) It is a mechanical or physical device, which does not necessarily use electric or electronic means to store the information. Preferred embodiments use human readable alphanumeric characters.

6) It is preferably marked on the outside with a recognizable symbol and the applicable web site address. It may also be marked “open for medical record code” and with any other relevant information, as with a medical alert bracelet or pendant.

What we claim as our invention is:

1. an information access system comprising:
a database;
at least one data record in the database;
a password access control for the database providing access to a record in the database only in response to presentation of a password unique to that record;
password record media recording respective ones of the passwords; and
a medium carrier containing each password record medium and securing the password record medium against access, the password record medium being releasable from the carrier only upon destruction of the integrity of the carrier.

2. A system according to claim 1 that allows “one-time” access to a database record. Once the need for access has passed, a new password, a new record medium and a new medium carrier are produced for the authorized user.

4. It may use encryption coding for the transmission of the data, similar to that used by banks for Internet banking, but may be more secure, utilizing more digits for key and access code.

5. It is a mechanical or physical device, which does not necessarily use electric or electronic means to store the information. Preferred embodiments use human readable alphanumeric characters.

6. It is preferebly marked on the outside with a recognizable symbol and the applicable web site address. It may also be marked “open for medical record code” and with any other relevant information, as with a medical alert bracelet or pendant.
